(19) United States
(12) Patent Application Publication
(10) Pub. No.: US 2007/0087073 A1
(43) Pub. Date: Apr. 19, 2007

(54) Tabletting press

(76) Inventors: Tahseen A. Chowdhury, Washington Township, NJ (US); Sean Scully, Rockaway, NJ (US)

Correspondence Address: STERNE, KESSLER, GOLDSTEIN & FOX P.L.L.C., 1100 NEW YORK AVENUE, N.W., WASHINGTON, DC, 20005, US

(21) Appl. No.: 11/508,223

(22) Filed: Aug. 23, 2006

Related U.S. Application Data
(60) Provisional application No. 60/710,141, filed on Aug. 23, 2005.

(51) Int. Cl. B29C 43/02

(52) U.S. Cl. 425/408; 425/345; 425/406

(57) ABSTRACT

A tabletting press for making compressed products that includes an upper punch, a lower punch, a die and a core pin. The core pin is located in the lower punch and moves with respect to the lower punch. Movement of the upper punch and the lower punch toward each other within the die and the location of the core pin create a compressed product having a hole. The product may be a lollipop containing a pharmaceutical.

### FIELD OF THE INVENTION

The present invention relates generally to tabletting presses and, in particular to a tabletting press configured to produce compressed lollipops.

### BACKGROUND OF THE INVENTION

Rotary tabletting presses are often used to rapidly produce high volumes of compressed tablets. For example, they may be used for rapidly producing candy or pharmaceuticals in extremely high volumes.

Although the processes employed for creating pharmaceutical tablets with rotary tabletting presses are well-established and easily controlled, tablets are not always the preferred dosage form. Oftentimes, it is preferable to provide a pharmaceutical material in the form of a compressed lollipop for administration of the pharmaceutical through the mucosal tissues of the mouth, pharynx, and esophagus.

Generally the production of compressed lollipops has required specially designed lollipop presses. Similar to conventional tablet presses, those presses often include an upper punch, a lower punch and a die and in use, a powdered material is placed within the die and the two punches are moved toward each other to compress the material. However, unlike tablet presses the lollipop presses generally include a tapered nipple to create a hole for a stick on the upper punch and an extra deep die. One disadvantage of lollipop presses is that after receiving the required amount of powder, the lower punch must be pulled down within the die, unlike conventional tablet presses. The lower punch must be pulled down because the upper punch of the lollipop press includes the nipple and space must be left within the die so that the material will not overflow when the upper punch is lowered. As a result, an extra deep die is required. Another disadvantage is that the upper punch requires a travel that is significantly longer than conventional tabletting presses because the upper punch must be moved further into the die to avoid overflow and further out of the die so that the nipple does not impede ejection of the compressed product. Because of the requirements for a deep die and increased travel, the lollipop presses have tended to be larger and more expensive to produce. In addition, because the tapered nipple does not move with respect to the upper punch, the nipple must be configured so that when the upper punch is removed, the compressed lollipop will not adhere to the nipple. As a result, the nipple must have a significant taper. However, the tapered nipple results in the hole in the compressed lollipop being tapered, which makes mounting a stick more difficult and oftentimes requires additional processes such as including an adhesive in the hole.

Further, due to size limitations, the manufacture of compressed lollipops require modified tabletting presses. For example, a “standard” tabletting press includes a die plate having a thickness of about 30 mm. Such a die plate supports a standard die having a die height of about 22 mm and a fill capacity of about 20 mm. The tablet resulting from such dies may be too small to adequately serve as a lollipop. Therefore, to increase the size of the resulting compress, known lollipop presses include what is referred to as a “double tall” die plate. Double tall die plates have a thickness between about 50 mm and about 60 mm. Therefore, they support large dies, which produce larger tablets. However, the need for such die plates adds to the costs and complexities of the manufacture of compressed lollipops.

Other tabletting press have also been created that form holes in a compressed product. For example, U.S. Pat. No. 6,361,306 describes a tabletting press for producing ring-shaped compressed tablets. The tabletting press includes an upper punch, a lower punch, a central pin and a die. The central pin extends to the top surface of a die and remains stationary with respect to the die and the lower punch. After the die is filled with powdered material, the top punch is lowered to meet the top surface of the central pin. Because the central pin is stationary with respect to the die, the press relies entirely on the lower punch to compress the powdered material.

Therefore, a need exists for a tabletting press that may be used to efficiently produce compressed products having holes and, in particular, compressed lollipops.

### SUMMARY OF THE INVENTION

A tabletting press for making compressed lollipops includes a housing (or turret), a die, an upper punch, a lower punch and a core pin. The die includes a compression bore and the die is supported by the housing. The upper punch is located above the die and is movably supported by the housing such that an end portion of the upper punch is movable into the bore of the die while in compression. The lower punch is located below the die and is movably supported by the housing such that an end portion of the lower punch is movable into the bore of the die during compression. The core pin is located in the lower punch and is movable with respect to the lower punch. The core extends into the compression bore of the die.

A method of making a compressed lollipop includes the steps of providing a tabletting press including a die, an upper punch, a lower punch, and a core pin located in and extending from the lower punch, wherein the upper punch is movably supported above the die and the lower punch is movably supported below the die; moving the lower punch such that an upper portion of the lower punch is inserted into a compression bore of the die and the core pin extends further into the compression bore; filling the compression bore of the die with powdered material; moving the upper punch into the bore of the die toward the lower punch thereby compressing the powdered material that is within the bore and between the upper punch and the lower punch to create a compressed lollipop; moving the upper punch out of the bore of the die; and moving the lower punch with respect to the die and the core pin toward the upper punch thereby ejecting the compressed lollipop.

In accordance with another aspect of the invention, there is provided a die for use in a die plate of a tabletting press comprising a main body having a generally cylindrical shape and a first diameter, an extended region extending from the main body, wherein the extended region has a second diameter which is smaller than the first diameter, and a compression bore extending through the main body and the extended region. The height of the die is generally greater than about 22 mm. Preferably, the height of the die is between about 30 mm and about 35 mm. In one embodiment, the height of the main body of the die is about 22 mm and the height of the extended region is between about 2 mm and about 13 mm.

### BRIEF DESCRIPTION OF THE FIGURES

Embodiments of the present invention will now be described more fully with reference to the accompanying drawings in which like reference numerals indicate similar structure.

FIG. 1 is a cross-sectional view of the rotary tabletting press of the present invention.

FIG. 2 is an elevational side view of a lower punch assembly that may be used in the rotary tabletting press of FIG. 1.

FIG. 3 is a side view of the lower punch assembly of FIG. 2 extending into a die with the core pin shown in phantom.

FIG. 4 is a cross-sectional view of a portion of the rotary tabletting press incorporating the lower punch assembly of FIG. 2 in a fill configuration.

FIG. 5 is a cross-sectional view of a portion of the rotary tabletting press incorporating the lower punch assembly of FIG. 2 in a compression configuration.

FIG. 6 is a cross-sectional view of a portion of the rotary tabletting press incorporating the lower punch assembly of FIG. 2 in an ejection configuration.

FIG. 7 is a partial cross-section of a compressed lollipop made with the present invention.

### DETAILED DESCRIPTION OF THE INVENTION

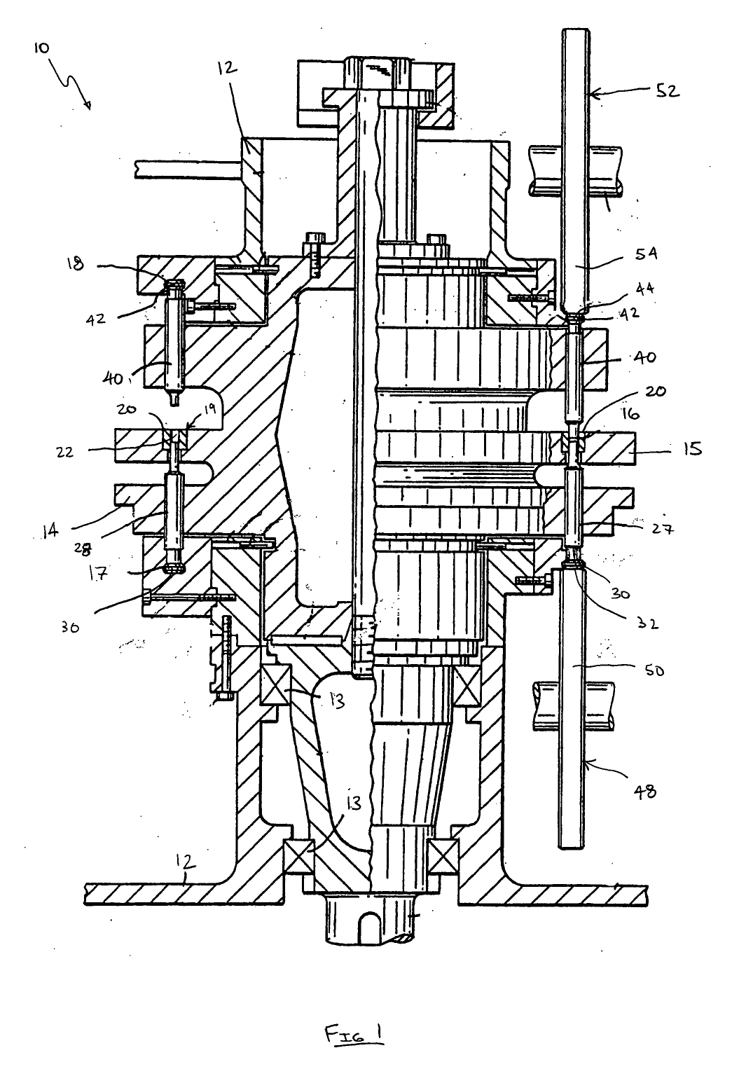

A rotary tabletting press for producing compressed lollipops from powdered materials is generally indicated by reference numeral 10 as shown in FIG. 1. The press 10 generally includes a stationary housing 12, a rotating die plate 14, a plurality of dies 19, a plurality of lower punch assemblies 27 and a plurality of upper punches 40. Press 10 can generally withstand high compression forces. For example, an embodiment of press 10 can withstand compression forces up to about 27 KN.

Die plate 14 is supported within stationary housing 12 by a pair of bearings 13 such that die plate 14 is rotatable within stationary housing 12. Die plate 14 includes a plurality of bores 16 that are distributed around an outer flange 15 of die plate 14. Each bore 16 is configured to hold a die 19. Lower punch assemblies 27 and upper punches 40 are supported by die plate 14 such that one lower punch assembly 27 and one upper punch 40 corresponds to each die 19. It should be appreciated that stationary housing 12 and die plate 14 may be constructed from multiple components as shown in FIG. 1, however, the details of which will not be described herein.

Die 19 includes a compression bore 22 and a retaining groove 24. As described above, each die 19 is located within a bore 16 of die plate 14. Die 19 may be retained within bore 16 by including an engagement feature, such as a set screw (not shown) within die plate 14, that is configured to engage with retaining groove 24. Die 19 is located within bore 16 such that an upper surface 20 of die 19 is flush with an upper surface of outer flange 15 of die plate 14. Die 19 may also include a step 26 for limiting the travel of upper punch 40 within compression bore 22. Due to the configuration of the press, described below, die 19 does not need to be extra deep. For example, die 19 may provide a punch penetration of 2.5-8 mm rather than the minimum punch penetration of 14 mm required in extra deep die lollipop presses.

A lower punch 28 of lower punch assembly 27 is slidably supported by die plate 14 such that lower punch 28 is located below and aligned with compression bore 22 of a corresponding die 19. An upper portion of lower punch 28 extends within compression bore 22 and is configured to be slidably received therein. A compression surface 34 is included on the extreme upper end of lower punch 28. Compression surface 34 may be flat, convex or concave. As shown, compression surface 34 is generally concave and forms a ring. Lower punch 28 includes a head 30 that is slidably received within a lower control slot 17 that is included in stationary housing 12. The distance between outer flange 15 of die plate 14 and lower control slot 17 varies around the circumference of stationary housing 12. Lower punch 28 and core pin 56 may be made of stainless steel, aluminum, composite or any other material known in the art that is resistant to corrosion. For example, lower punch 28 may be fabricated from D2 steel, S7 stainless steel, 408 steel, A2 steel, 440 steel or Carbide.

Upper punch 40 is slidably supported by die plate 14 such that upper punch 40 is located above and aligned with compression bore 22 of a corresponding die 19. Upper punch 40 is movable from a fill/eject position wherein upper punch 40 is spaced above compression bore 22, as shown on the left side of FIG. 1, to a compression position wherein a lower portion of upper punch 40 is inserted into compression bore 22, as shown on the right side of FIG. 1. A compression surface 46 is included on the extreme lower end of upper punch 40. Compression surface 46 may be flat, convex or concave. As shown, compression surface 46 is convex and spherical. Upper punch 40 includes a head 42 that is slidably received within an upper control slot 18 that is included in stationary housing 12. The distance between outer flange 15 of die plate 14 and upper control slot 18 varies around the circumference of stationary housing. Upper punch 40 may be made of stainless steel, aluminum, composite or any other material known in the art that is resistant to corrosion. For example, upper punch 40 may be fabricated from D2 steel, S7 stainless steel, 408 steel, A2 steel, 440 steel or Carbide.

It shall be appreciated that compression surfaces 34 and 46 may have various shapes. The shapes may be designed to alter the amount of powder that may be received in die 19. Additionally, compression surfaces 34 and 46 may be designed so that the compressed lollipop is convenient and comfortable for administration of its contents by sucking action in the buccal cavity. Further, compression surfaces 34 and 46 may be shaped to improve the ability to perform subsequent operations on a compressed lollipop, such as installation of a stick, or handle.

When press 10 is operated, die plate 14 rotates within stationary housing 12. While die plate 14 rotates, head 30 of lower punch 28 tracks within lower control slot 17 thereby forcing lower punch 28 to move up and down with respect to die plate 14. Similarly, while die plate 14 rotates, head 42 of upper punch 40 tracks within upper control slot 18 causing upper punch to move up and down. Lower control slot 17 and upper control slot 18 are configured such that the movement of lower punch 28 is choreographed with the movement of upper punch 40 so that a tablet is formed within each die during each revolution of die plate 14. In other words, for each revolution of die plate 14, each set of corresponding lower punch 28, die 19 and upper punch 40 is cycled from a fill configuration to a compression configuration and further to an ejection configuration, as will be described in greater detail below.

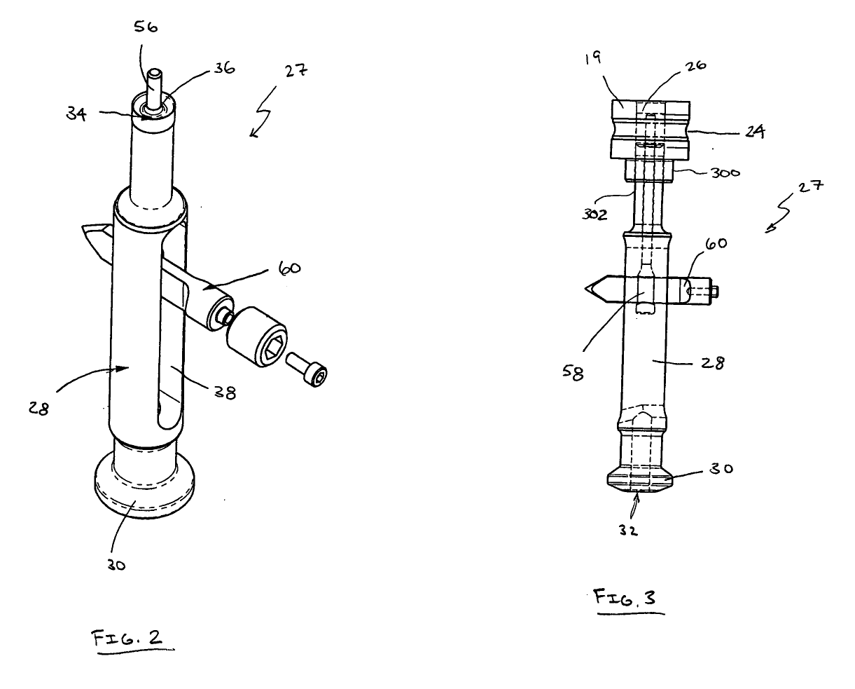

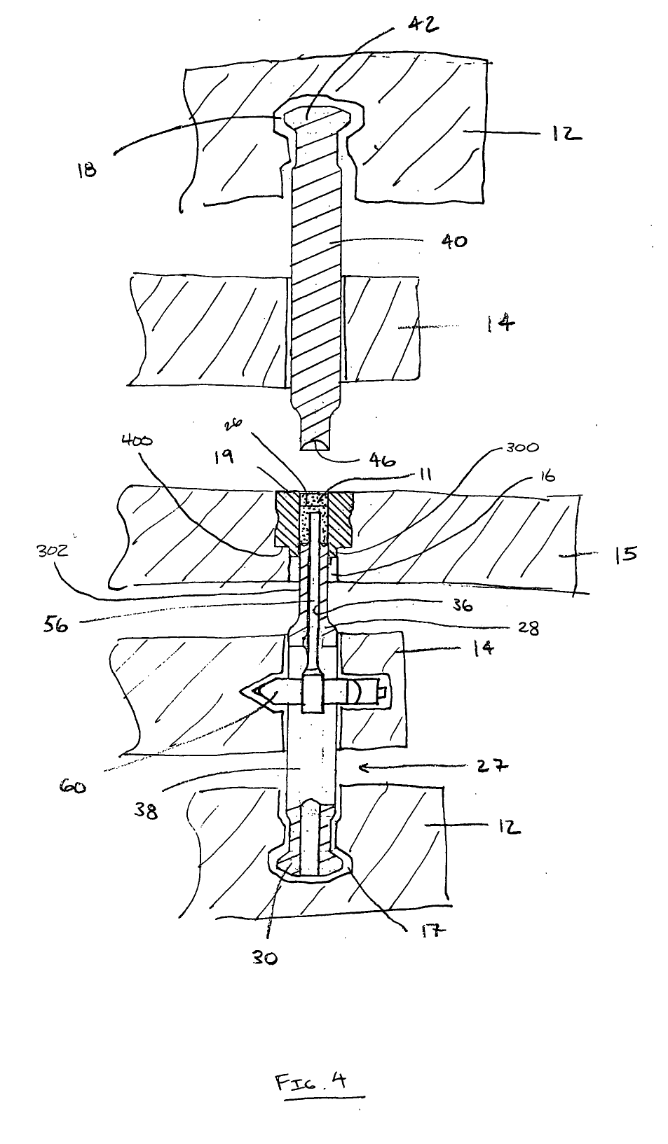

FIGS. 2 and 3 illustrate lower punch assembly 27 in greater detail. Lower punch assembly 27 may be used within press 10 to create compressed lollipops. Lower punch assembly 27 generally includes lower punch 28, a core pin 56 and a retainer key 60. Core pin 56 is slidably received within a bore 36 that extends through lower punch 28. Core pin 56 is provided to create a hole in a final compressed product for receiving a stick.

Retainer key 60 extends into a slot 38 that is included in lower punch 28 and through a retaining slot 58 that is included in core pin 56. Retainer key 60 is able to slide within slot 38 such that the position of core pin 56 within lower punch 28 can be controlled through movement of retainer key, or conversely, core pin 56 may be held stationary via retainer key 60 while lower punch 28 is moved. Retainer key 60 is mounted to die plate 14 such that it does not move relative to die plate 14. Alternatively, retainer key 60 may be coupled to die plate 14 through an actuator, or via a retainer key control slot so that retainer key 60, and core pin 56, may be moved with respect to die plate independently from lower punch 28.

FIG. 3 shows a modified die 19, for use in a standard die table. Die 19 includes an extended region 300. As such, die 19 includes a main body having a first diameter and an extended region 300 having a second diameter smaller than the first diameter. Extended region 300 of die 19 allows an upper portion 302 of lower punch 28 to be drawn further down and thereby provide an increased fill capacity within the compression bore of die 19. As such, while standard dies have a die height of about 22 mm and provide a fill capacity of about 20 mm, the presented modified die 19 has a die height of up to about 35 mm and provides a fill capacity of as much as 33 mm. An advantage of die 19 is that it is suited to be supported within a standard die plate having a thickness of about 30 mm, but may still provide a fill capacity of as much as about 33 mm. The height of die 19 is generally greater than about 22 mm. Preferably, the height of die 19 is between about 30 mm and about 35 mm. In one embodiment, the height of the main body of die 19 is about 22 mm and the height of the extended region is between about 2 mm and about 13 mm.

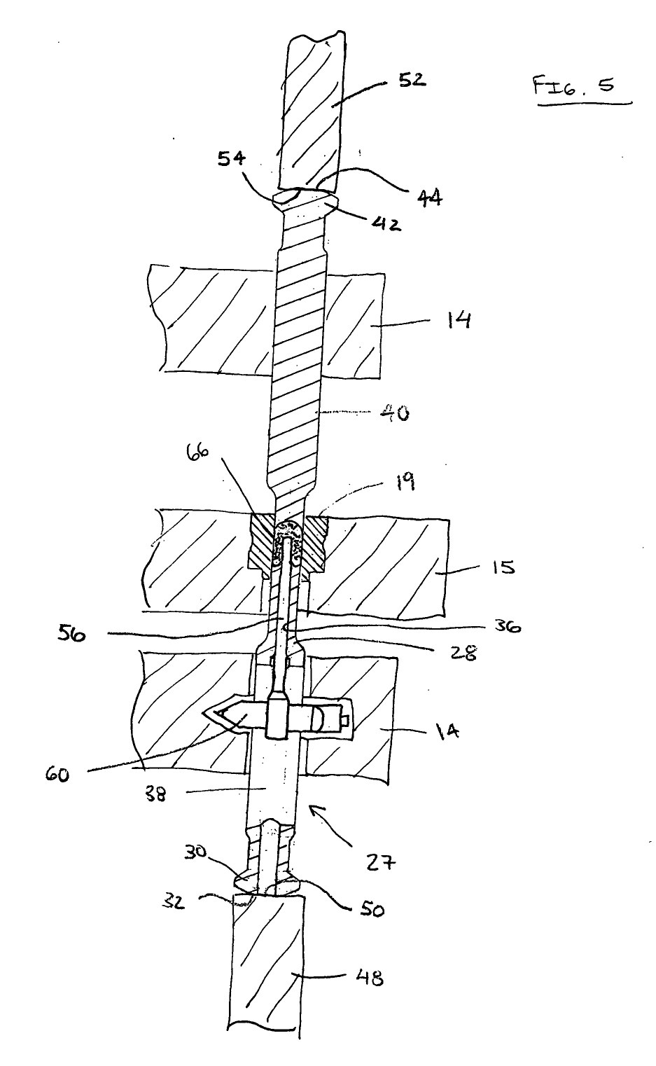

FIGS. 4-6 illustrate various configurations of a lower punch assembly 27, die 19 and upper punch 40, the configurations corresponding to a fill configuration, a compression configuration and an ejection configuration, respectively. As shown, die 19 is supported on a step 400 within bore 16 of flange 15. Extension 300 extends deeper into bore 16 and thereby provides an extended fill capacity for compression bore 22.

In the fill configuration, shown in FIG. 4, upper punch 40 is spaced above and away from compression bore 22 and compression surface 34 of lower punch 28 is positioned within a lower portion of compression bore 22. In addition, core pin 56 extends upward past compression surface 34 of lower punch 28 and further into compression bore 22. The remainder of compression bore 22 is filled with powdered material 11 so that the material is flush with upper surface 20 of die 19.

The ability to fill compression bore 22 with powdered material 11 flush with upper surface 20 of die 19 may be especially beneficial when pharmaceutical materials are employed. The quantity of powdered material 11 that is compressed is directly related to the final dosage of the compressed product. As a result, it is especially important to provide easy control over the amount of powdered material 11 that is included. Because powdered material 11 can be filled flush with a top surface of the die, the dosage can be easily controlled by precisely machining and calibrating the die prior to using the press rather than directly controlling the flow of the powdered material 11. During filling a relatively simple mechanism may be employed that assures that the powdered material 11 is flush with upper surface 20 of die 19. For example a bulk hopper may be used to initially fill compression bore 22 and a brush or squeegee may be used to level powdered material 11 within compression bore 22.

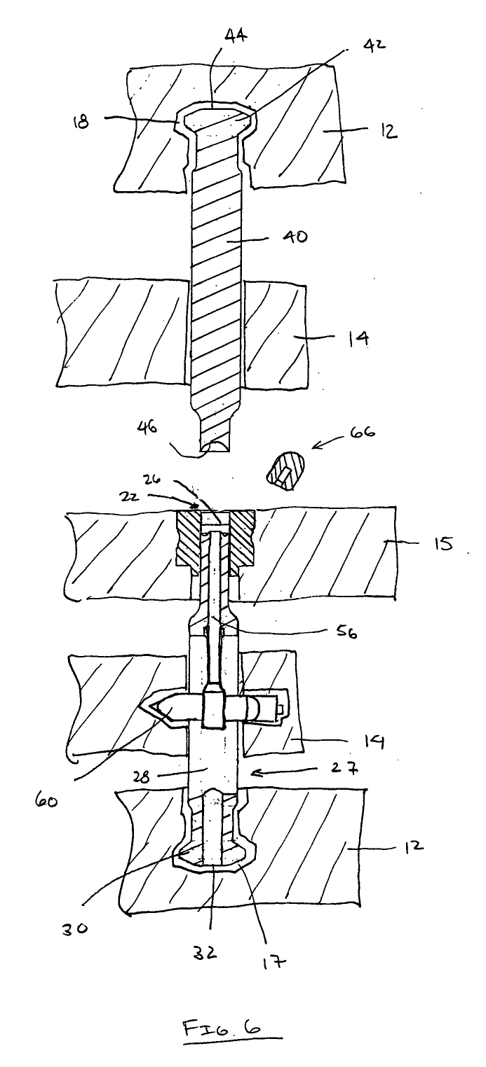

After compression bore 22 is filled, powdered material 11 is compressed into a compressed lollipop 66. FIG. 5 illustrates the compression configuration of lower punch assembly 27, die 19 and upper punch 40. In the compression configuration, upper punch is moved downward such that compression surface 46 of upper punch 40 extends into compression bore 22 and encloses powdered material 11 within compression bore 22. In the compression configuration, cam surface 32 of head 30 of lower punch 28 and cam surface 44 of head 42 of upper punch 40 engage a cam surface 50 of a lower cam 48 and a cam surface 54 of an upper cam 52, respectively. Lower and upper cams 48, 52 rotate causing lower punch 28 to move upward and upper punch to move downward thereby compressing powdered material 11 enclosed within compression bore 22.

In the present embodiment, when powdered material 11 is compressed a space remains between compression surface 46 of upper punch 40 and core pin 56 thereby creating a blind hole in the final compressed lollipop 66. It shall be appreciated that the apparatus may be configured such that the distance between core pin 56 and compression surface 46 of upper punch 40 is adjustable so that the hole may be a blind hole or a through hole. However, since it is the intention of the invention to create a compressed lollipop 66, the statement wherein “the end portion of the upper punch is spaced from the core pin when the tabletting press is in a position of compression,” is intended to mean that core pin 56 does not contact compression surface 46 of upper punch 40 when press 10 is in a position of compression. As such, the combination of upper punch 40, lower punch 28, and core pin 56 serve as means for creating a compressed lollipop 66.

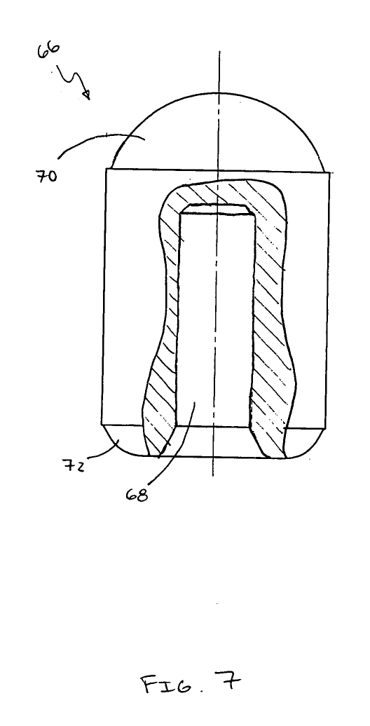

After powdered material 11 is compressed to create the compressed product 66, die plate 14 is rotated and lower punch assembly 27, die 19 and upper punch 40 move to an ejection configuration, as shown in FIG. 6. In the ejection configuration, upper punch 40 is spaced above and away from compression bore 22 and lower punch 28 is extended upward within compression bore 22 thereby pushing the compressed lollipop 66 out of compression bore 22. Core pin 56 remains stationary with respect to die plate 14 and the movement of lower punch 28 upward with respect to core pin 56 causes the compressed lollipop 66 to slide off of core pin 56. Because of the relative motion between the lower punch and the core pin, it is not necessary to use a tapered core pin, or if a tapered core pin is preferred, the taper may be reduced. As a result, subsequent insertion of a stick into the compressed lollipop is simplified.

It should be appreciated that the press described above may be used to create a large variety of compressed lollipops, including candies and pharmaceuticals. For example, in one pharmaceutical application a 2000 gram mixture of Fentanyl Citrate, confectioner's sugar, various other excipients and flavoring are compressed to form a compressed lollipop.

Compressed lollipop 66 is shown in FIG. 7. Compressed lollipop 66 includes a generally cylindrical stick hole 68 for subsequent insertion of a lollipop stick, or handle. Stick hole 68 may be tapered, but does not need to be tapered so that the subsequent insertion of a stick, or handle, is simplified and requires minimal additional processing. An upper surface 70 of compressed lollipop is generally dome-shaped and convex and corresponds to compression surface 46 of upper punch. Similarly, a lower surface 72 of compressed lollipop 66 is generally shaped as a convex ring corresponding to compression surface 34 of lower punch 28. It should be appreciated that the shape of compressed lollipop 66 can be flat, concave, convex or any other shape that would allow removal from press 10 and that is aesthetically acceptable.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A tabletting press for making a compressed product, comprising:
a stationary housing;
a die plate supported by the housing;
a die including a compression bore, the die being supported by the die plate;
an upper punch located above the die and movably supported by the housing such that an end portion of the upper punch is movable into the compression bore;
a lower punch located below the die and movably supported by the housing such that an end portion of the lower punch is movable into the compression bore; and
a core pin slidably disposed within the lower punch so as to provide relative movement between the core pin and the lower punch;
wherein the end portion of the upper punch is spaced from the core pin when the tabletting press is in a position of compression.

2. The tabletting press according to claim 1, wherein the die plate is rotatably supported by the stationary housing.

3. The tabletting press according to claim 1, wherein the die has a generally cylindrical shape.

4. The tabletting press according to claim 3, wherein the die includes a main body having a first diameter and an extended region having a second diameter smaller than the first diameter.

5. The tabletting press according to claim 1, wherein the lower punch includes a concave compression surface.

6. The tabletting press according to claim 1, wherein the upper punch includes a concave compression surface

7. A method of making a compressed product from a powdered material, comprising the steps of:
providing a tabletting press including a die, an upper punch, a lower punch, and a core pin located in and extending from the lower punch, wherein the upper punch is movably supported above the die and the lower punch is movably supported below the die;
moving the lower punch such that an upper portion of the lower punch is inserted into a compression bore of the die and the core pin extends further into the compression bore;
filling the compression bore of the die with a powdered material;
moving the upper punch into the compression bore of the die toward the lower punch such that it is spaced from the core pin thereby compressing the powdered material that is within the compression bore and between the upper punch and the lower punch to create a compressed lollipop;
moving the upper punch out of the compression bore of the die; and
moving the lower punch with respect to the die and the core pin toward the upper punch thereby ejecting the compressed lollipop.

8. The method of making a compressed product according to claim 7, further comprising the step of:
leveling the material within the compression bore after the step of filling the compression bore with powdered material such that the powdered material is flush with a top surface of the die.

9. The method of making a compressed product according to claim 7, wherein when the upper punch is moved toward the lower punch to compress the powdered material, the lower punch is moved toward the upper punch.

10. The method of making a compressed product according to claim 7, wherein the powdered material contains a pharmaceutical.

11. A die for use in a die plate of a tabletting press comprising:
a main body having a generally cylindrical shape and a first diameter;
an extended region extending from the main body, wherein the extended region has a second diameter which is smaller than the first diameter; and
a compression bore extending through the main body and the extended region.

12. The die of claim 11, wherein the height of the die is greater than about 22 mm.

13. The die of claim 11, wherein the height of the die is between about 30 mm and about 35 mm.

14. The die of claim 11, wherein the height of the main body of the die is about 22 mm and the height of the extended region is between about 2 mm and about 13 mm.
